(19) United States
(12) Patent Application Publication
(10) Pub. No.: US 2019/0236416 A1
(43) Pub. Date: Aug. 1, 2019

(54) ARTIFICIAL INTELLIGENCE SYSTEM UTILIZING MICROPHONE ARRAY AND FISHEYE CAMERA

(71) Applicant: Microsoft Technology Licensing, LLC, Redmond, WA (US)

(72) Inventors: Zhenghao Wang, Bellevue, WA (US); Xuedong Huang, Bellevue, WA (US); Lijuan Qin, Redmond, WA (US); Kun Wu, Beijing (CN); Huaming Wang, Redmond, WA (US)

(21) Appl. No.: 15/885,518

(22) Filed: Jan. 31, 2018

(51) Int. Cl. G06K 9/62; H04N 5/232; H04N 5/262; G06K 9/00; G10L 17/22; G06F 3/16; G06F 3/01; H04R 1/22; G06K 7/14; G06K 7/10; G06N 3/08

(52) U.S. Cl. CPC G06K 9/6289; H04N 5/23238; H04N 5/23216; H04N 5/2628; H04N 13/0203; G06K 9/00288; H04R 1/2892; G06F 3/167; G06F 3/017; H04R 1/222; G06K 7/1417; G06K 7/10722; G06N 3/08; G10L 17/22

(57) ABSTRACT

In some embodiments, the disclosed subject matter involves a system and method relating to using an ambient capture device including a fisheye camera and a microphone array to capture audio and video in an environment, for use in an artificial intelligence (Al) application. The device with fisheye camera may provide approximately a 360° audio and video view, at relatively low cost. An embodiment may utilize a speech and vision fusion model component. The speech and vision fusion model may be trained using deep learning to combine features from many different sources, including available sensor data from the capture device. A long short term memory (LSTM) model may inter or identify features such as, but not limited to: audio direction; vision detection and tracking; voice signature; facial signature; gesture recognition; and object identification. The fusion processing may be performed by a cloud server, enabling the capture device to remain less complex.

### TECHNICAL FIELD

An embodiment of the present subject matter relates generally to ambient artificial intelligence systems, and more specifically, to an ambient artificial intelligence device having a camera with fisheye lens coupled to a microphone array.

### BACKGROUND

Various mechanisms exist for capturing audio and video in systems using artificial intelligence (AI). An ambient sensor or collection device is one that typically collects information about the immediate environment surrounding the device, using one or more sensors. In some AI applications, a collection device is always on, waiting for visual or audio triggers to perform an action. Some AI devices need both audio and visual input for proper human interaction. Existing systems utilize a microphone and one or more cameras. With one camera, the device will have limited visual coverage of the environment (e.g., the device can only see objects at a certain angle). To cover additional fields of view, the device typically will have additional cameras. Not only does this make the hardware design complicated, it also introduces other challenges such as stitching the images from different cameras together. Systems with a single microphone may not be able to provide location information regarding the audio received. However, existing systems with both multiple cameras and multiple microphones require additional hardware and calculations to fuse and analyze the audiovisual data streams.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a high level block diagram illustrating a system for fusion of ambient audiovisual data in an artificial intelligence (AI) application, according to an embodiment;

FIGS. 2A and 2B illustrate an example capture or collection device, according to an embodiment;

FIG. 3 illustrates an example placement of the microphone array, according to an embodiment:

FIG. 4 illustrates an AI system with a capture device, according to an embodiment;

FIG. 5 is a flow diagram illustrating a method for capturing audiovisual data for an AI application, according to an embodiment;

FIG. 6 is a flow diagram illustrating a method for analyzing, processing and fusing audiovisual data collected by the ambient capture device, according to an embodiment; and

FIG. 7 is a block diagram illustrating an example of a machine upon which one or more embodiments may be implemented.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method for using an ambient capture device including a camera with a fisheye lens (also referred to herein as a fisheye camera) and a microphone array to capture audiovisual data in an AI environment. In an at least one embodiment, the microphone array comprises a plurality of microphones and is coupled to an upward-facing fisheye camera in the ambient capture device. The fisheye camera and microphone array may together provide approximately a 360° audio and video (e.g. audiovisual) collection area, at relatively low cost. This 360° collection area of the environment surrounding the device may be monitored in an always on mode, to identify audio and/or visual triggers from a user indicating that an action should be taken by an AI application controlled by the device. An embodiment may utilize a speech and vision fusion model component, which fuses audio data and visual data to provide richer data about the environment. For example, the fusion model may link recognized speech with an identified active human speaker. The fusion model may be trained using deep learning to combine features from many different sources, including available sensor data from the capture device. The fusion model may infer or identify features such as, but not limited to: audio direction; active speaker location in an image; active speaker movement; a voice signature; a facial signature; a gesture; and/or an object. In an embodiment, the fusion model includes a long short term memory (LSTM) model.

In existing systems, an additional layer of complexity and calculation may be required before operating an LSTM model to fuse the audiovisual data. In existing systems, multiple cameras are required to capture a 360° view. A single standard view camera may be panned to capture images in a 360° area, but the images will not have been taken at the same time. Each image will have a different time stamp, and patching the multiple images together will provide only an estimate of a 360° view. A PTZ (pan, tilt, zoom) camera might be used to mitigate shake or tilt from a handheld camera, but will still result in images having different time stamps. Thus, tracking moving objects is difficult when using single camera. Because of this, most existing artificial intelligence (AI) or virtual reality (VR) systems use multiple cameras. However, patching of the images is still required to provide a full 360° view of the environment. Moreover, calculations required to capture and patch the images from multiple sources are complex, and sometimes result in a lag time.

In an embodiment, a majority of the audiovisual fusion processing may be performed in the cloud. In this context, fusion of the audio and video may include temporally and/or spatially synchronizing audio and video events. The AI system may utilize advanced audiovisual encoding technology (e.g., High Efficiency Video Coding, HEVC, also known as H.265) to encode raw audiovisual data, and send the data to the cloud for processing. An embodiment may keep the raw data and allow processing of the data in an AI cloud server. The audio and video data may be fused and/or analyzed in the cloud to identify triggers or events that indicate a control or command for the AI application.

Various applications require fused audiovisual data to perform or operate according to the perceived intent of a user. Perceptual or contextual computing to determine the intent of a user, for instance, identifying a command intended by the user, is often referred to as AI. In traditional computing systems, a user is required to input commands, such as with a keyboard, in a specific syntax in order to be understood by the system. AI enables a user to speak more naturally, while an analysis may be undertaken to understand additional details about the visual context, such as a user's facial expressions and gestures. As used herein, an AI application is an application executing on one or more compute nodes that uses sensor data (e.g., audiovisual data) to determine a user's intent to interact with the application. In some cases, the intent is to perform an action, but may also be to conduct a query, issue a response, provide a reaction, etc.

In an example, a user operates a digital personal assistant such as Cortana®, available from Microsoft Corporation. In order to operate the personal assistant, an audio device needs to “listen” for commands and queries of the user. In an example, the personal assistant may take cues from the user's facial expressions along with the user's speech to determine the context of a question. In another example, a user may operate an application that relies on both spoken commands and hand gestures. In another example, an application may require face and/or voice recognition of an authorized user before initiating some commands, while other commands may be initiated by any user in the room. When multiple users are present in the environment, or a single user moves within the environment, a complete view of the environment, e.g., a 360° view, is advantageous over a narrow view. An array of more than one microphone may help locate an active speaker spatially, whereas a single microphone may not be adequate. A user may be identified by facial recognition, but use speech to initiate a command. Identifying that the location of the audio signals representing speech is co-located with the video images representing the user's facial features may provide a high probability or certainty that the authorized user spoke the commands. This identification may be performed by “fusing” the audio and video data to provide richer data about the environment. In an application, simultaneous or near-simultaneous speech recognition and gesture recognition may be required to be performed before initiating a command. For instance, security protocols may require that a specific command be spoken while simultaneously performing a specific hand gesture. In an application, a combination of speech, gesture, and facial or voice recognition may be required to unlock security features of the application, or even to login or shutdown the application. Embodiments as described herein provide a system for inexpensive collection of ambient audiovisual and the fusion and/or analysis of the audiovisual data for use by an application.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

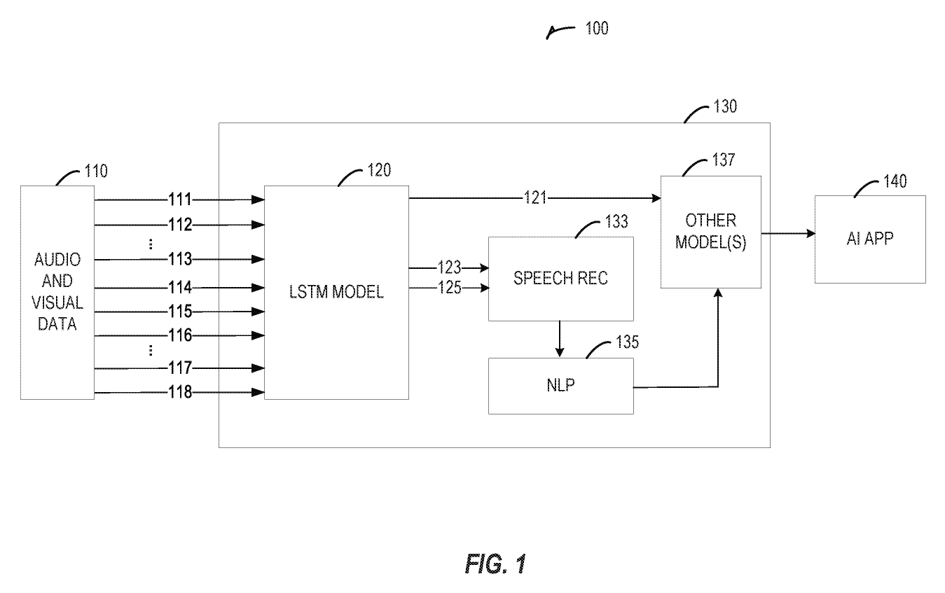

FIG. 1 is a high level block diagram illustrating a system 100 for fusion and analysis of ambient audiovisual data in an AI application, according to an embodiment. In an embodiment, an ambient capture device may collect audiovisual signals for analysis at 110. The signals may he pre-processed, compressed and/or encrypted before being sent to an analysis and fusion engine 130. Signals may be sent using multiple channels. In an example, audio may be sent in channels 111, 112, 113, video may be sent in channel 114, images of active speaker #1 may be sent in channel 115, a voice signature of active speaker #1 may be sent in channel 116, and additional active speaker images and voice signature may be sent in channels 117 and 118, respectively. It will be understood that there may be an audio channel for each microphone on the ambient capture device, and active speaker images and voice signatures may be collected for each active speaker in the room. In an embodiment, an LSTM model 120 in a recurrent neural network may be used to fuse and/or analyze the received audio and video. In this context, fusion of the audiovisual data may include temporally and/or spatially synchronizing that data, and correlating video image data with audio, speech and/or voice signature data. Other models may be present in analysis component 130.

It will be understood that content in channels 111-118 may vary based on pre-processing performed on the ambient capture device. For instance, a facial detection model on the ambient capture device may provide a channel with face detection Output (e.g., location or speaker ID). A face detection output may be empty, blank or null to indicate that no faces have been recognized. Face detection output may include an active speaker's direction relative to the microphone array. Face detection may also identify persons in the room that are not actively speaking. An audio sound source localization model may identify and provide sound source localization output (e.g., sound energy levels at different directions). In an embodiment, the face detection output and sound source localization output may be provided to the analysis component 130. In an embodiment, sound source separation may be used to produce an audio stream for each active speaker, which may be sent to the analysis model 130. It will be understood that various levels of analysis of the collected audiovisual data may be performed locally or in the cloud, or distributed among analysis components either locally or remotely.

Contextual and historical information may be important in the analysis of the audio with respect to the video. Humans do not start their thinking from scratch every second. For instance, the reader understands the meaning of this text based on understanding of each word in relation to the understanding of previous words. The reader will not throw away all knowledge and start thinking from scratch with each new sentence, paragraph, or section. Thoughts and knowledge have persistence. However, traditional artificial neural networks cannot maintain this persistence. For example, imagine a system is to classify what kind of event is happening at every point in a movie. It is unclear how a traditional artificial neural network could use its reasoning about previous events in the film to inform later ones. Recurrent neural networks address this issue. A recurrent neural network, as may be used in embodiments disclosed herein, includes inherent loops, which allow information to persist. In an embodiment an LSTM model 120, a type of recurrent neural network, may be used to assist in the fusion of the audio and video captured with the ambient capture device.

In an AI application, the ambient audiovisual data in the user environment are collected for use. In an example, a user may perform gestures or speak aloud to initiate actions in the AI system. In an example, the AI application may monitor and operate a conference among attendees. Voice recognition and user identification via voice signatures and physical location of the active speaker may enable various feature of the conference system, such as taking meeting notes and attributing comments to the correct participant. Once the audiovisual data 110 is collected by an ambient capture device, the data may be sent to an LSTM recurrent neural network model 120 via channels 111-118, for analysis and fusion. In an embodiment, the audiovisual data 110 is collected by sensors in the environment (e.g., sensors coupled to the ambient capture device), and then sent to a cloud server hosting the LSTM component 120. In an embodiment, the ambient capture device may be coupled to a local processor for performing the fusion analysis 120. The ambient capture device may be directly coupled to the fusion analysis processor 130, or may communicate wirelessly or via a communication device. The LSTM model 120 provides fused data to additional analysis or fusion models 137 before sending data to the AI application 140. Communication may be effected using a wired Ethernet port, wirelessly via Wi-Fi®, Bluetooth®, Near field communication (NFC) or other communication mechanisms coupled to the ambient capture device.

In an embodiment, The LSTM model 120 may provide some video and facial recognition to assist in fusion of the audio data with identified speakers. A video stream in channel 121 may provide the video stream to other models 137, for instance for gesture recognition. One or more models 137 may recognize gestures, facial movements and characteristics, as well as, identify a user's location in the environment, to assist in the identification of which user is uttering which audio data, gestures performed, facial expression or emotion, etc. In an embodiment, some facial recognition may be performed by the ambient capture device and speaker ID sent with the audio channels, to the LSTM model 120. In an embodiment, the active speaker location may be recognized by the ambient capture device, but the active speaker's identity may be determined by the analysis engine 130. Audio channels 123, 125 may include audio streams from various active speakers, with a speaker identifier (ID), when available, as inputs to a speech recognition engine 133. The speech recognition engine 133 may identify speech from the audio streams, and may include the user/speaker ID to identify which user is speaking. The recognized speech may then be passed to a natural language processor (NLP) 135 to identify commands or other speech associated with the users. The video processed data and speech data may be provided to additional trained models 137, as desired, to further determine the intent or speech of the users. For instance, when a spoken command and hand gesture are both required before an action is performed, the additional model 137 may use a trained model to identify gesture-spoken command combinations and then send an appropriate command or instruction to the AI application 140.

In another embodiment, fused and analyzed data may be sent directly from a video and facial recognition engine in the LSTM 120 and the NLP engine 135 to the AI application 140 (e.g., without use of the additional model 137). In this example, the AI application may have its own model for further fusing and analysis of the audiovisual data to determine an appropriate action. In another embodiment, the LSTM model 120 may be integrated with one or more of the various other models 133, 135, 137 for video and audio recognition and provide fused results directly to the AI application 140. It will be understood that a variety of architectures may be implemented to fuse and analyze the audiovisual data 111-118 received from the ambient capture device. Various levels of fusion models, video recognition models, and audio/speech recognition models, etc. may be distributed among components that are either communicatively coupled to the ambient capture device, provided by a cloud service, or integrated with the AI application.

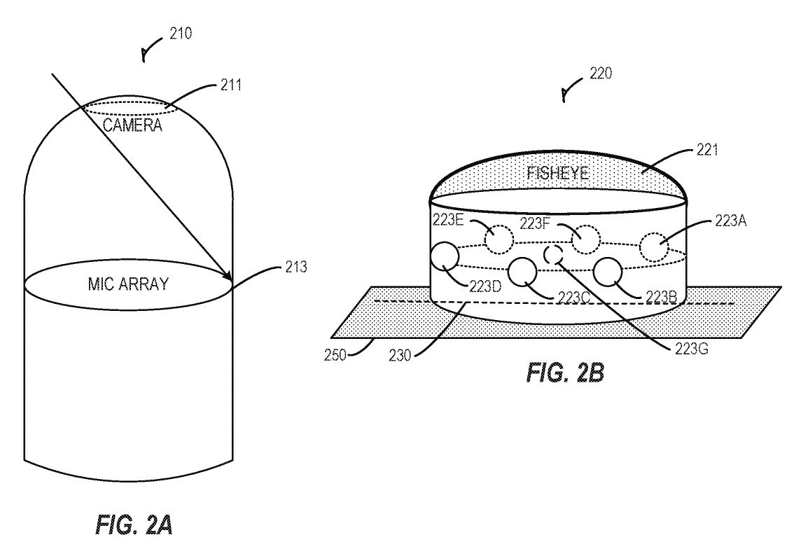

An embodiment avoids the unwieldy calculations and additional hardware required for multiple cameras by using an ambient capture device having a single fisheye camera coupled to a microphone array or multiple microphones. FIGS. 2A and 2B illustrate an example ambient capture device. In an embodiment, ambient capture device 210 may be cylindrical in shape with a fisheye camera 211 at the top of and facing up with respect to the device. A microphone array 213 may he coupled to the device 210 below the camera 211 and placed around the cylinder to capture audio in 360°. It should be noted that the device in FIG. 2A may not be drawn to scale. In order to capture optimal 360° vision (e.g., video or still images), it may be desirable for the fisheye camera to be close to a floor or table surface 250. In an embodiment, the device may be short and squat to avoid blind spots below the camera 211. In an embodiment, the fisheye camera may be placed in close proximity to a microphone array 213. In the example illustrated in FIG. 2B, seven microphones 223A-G are included in the microphone array 223. As shown, six microphones 223A-F may be placed around the device in a plane and more less equidistant from the center of the device, and a seventh microphone 223G may be placed in the center. It will be understood that the device may be made of audio penetrable material, such as a light fabric, grille, or mesh, and that the microphones 223 are not blocked by the fisheye camera 221 or other structural portions of the device 220, so that the sound is not obstructed.

In an embodiment, the fisheye camera may be approximately 30 cm from the base of the device 220, and the microphone array 223 may be affixed approximately 15 cm above the base 230. When in operation, the device 220 may sit on, or be affixed to, the floor or table 250 in an environment. As the device 220 is placed closer to the floor, the 360° horizontal field of view (HFOV) may include more of the environment. The fisheye camera 221 is typically affixed to the device 220 facing up, so the ceiling may be in the field of view. It will be understood that other shapes, sizes or configurations of the device 220 and placement of the fisheye camera 221 and microphone array 223 may be implemented, with some adaptation to provide both similar and varying results.

In an embodiment, acoustic parameters for audio capture may vary depending on the specifications of the microphones. An example of acoustic specifications for an embodiment are shown below in Table 1. In an embodiment, the acoustic parameters may apply to the whole audio subsystem, e.g., captured pulse code modulation (PCM) data, not just the microphones. The captured audio may produce adequate speech recognition accuracy for use in an AI application. One of ordinary skill in the art, with the benefit of the present disclosure, will appreciate that various acoustic parameters may be utilized to achieve speech recognition accuracy, and that the example parameters in Table 1 are for illustrative purposes.

TABLE 1
Example Acoustic Parameters

| | |
|---|---|
| Sensitivity (1 kHz 94 dB SPL) | −26 +/− ≤0.1 dB FS |
| Signal-noise ratio (SNR), | ≥64 dB A |
| including power supply | |
| and digital filter noise | |
| Frequency Response | 50 −> 16 kHz (+/−≤3 dB) |
| Total Harmonic Distortion | ≤1% (105 dB SPL) ≤5% (115 dB SPL) |
| Directionality | Omnidirectional (≤1 dB sensitivity |
| | difference for 50 −> 16 kHz) |
| Variance between | ≤1 dB sensitivity difference for |
| microphones | 50 −> 16 kHz |
| Longevity | No permanent loss of performance at: |
| | Maximum SPL ≥160 dB |
| | Maximum shock ≥10,000 g |
| | Temperature Range −40° C. |
| | to +80° C. |

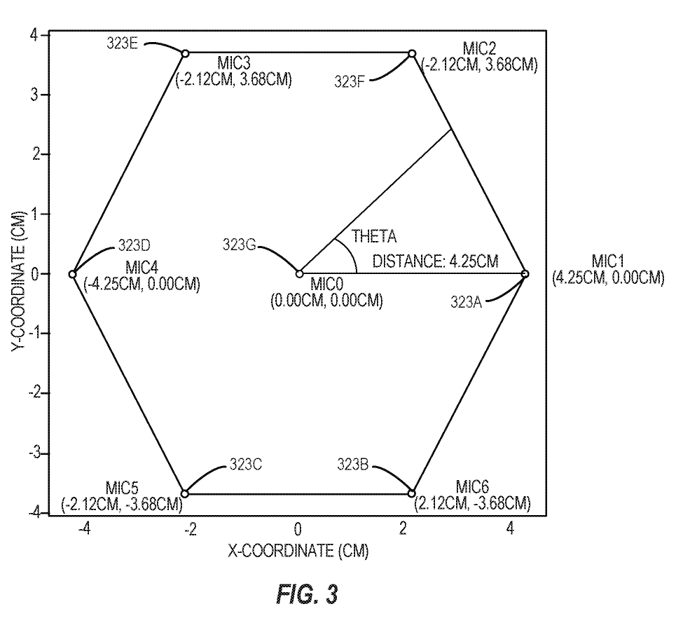

FIG. 3 illustrates an example placement of the microphone array 323, according to an embodiment. In an embodiment, the device includes seven microphones placed in the same plane. Six microphones 323A-F may be placed in a circular or hexagonal pattern in the plane, approximately 4.25 cm from a center point. A seventh microphone 323G may be placed at the center point. In an embodiment, the configuration of seven microphones comprise microphones of similar specification. It will be understood that additional processing of the audio data received from the microphone array may be necessary to normalize or adjust the audio when the microphones are dissimilar. In an example implementation, the microphone array 323 may comprise seven digital microelectromechanical systems (MEMS) microphones with ports facing upwards. It will be understood that better performance may result when the microphones are not obstructed by sound absorbing or blocking components, such as a circuit board or device case. In an embodiment, similar microphones are clocked using the same clock source in the device (not shown). The clocking or timestamping of the audio may assist with synchronization and fusion of the audiovisual data. The ambient capture device may decimate all microphone signals to 16-bit 16 kHz PCM data. In this context, decimation is the process of reducing the sampling rate of the signal. For automatic speech recognition, frequency bands higher than 8 kHz may be unnecessary. Therefore, a sampling rate of 16 kHz may be adequate. Decimation reduces bit rate without compromising required accuracy. In an embodiment, the capture device may support additional bit depths and sampling frequencies. In an embodiment, the capture device may not allow changing data width and sampling frequency, to reduce driver complexity and improve stability. The microphones may be mounted using any adequate mechanical dampening mechanism, for instance, rubber gaskets, to reduce vibrations and noise. It will be understood that more or fewer microphones may be present in the microphone array. However, fewer microphones may introduce some uncertainty of speaker location. Additional microphones may provide increased certainty or resolution of the audio, but at a cost of more hardware and additional complexity of calculation.

In an embodiment, an audio speaker may be located at the bottom, or base, of the device, for audio feedback to the user. The audio speaker may be used for feedback announcements, or be an integral part of the AI application. For instance, in an AI application for conference management, a user may request meeting minutes to be read back to the attendees. An integrated speaker in the device may provide feedback or request instructions or commands for operation. If a spoken command is not understood, a request to repeat the command may be played through the speaker. To reduce acoustic feedback, the audio speaker may face the opposite direction from the microphone array. Audio played back via the audio speaker may be looped back as an additional synchronized microphone channel.

Referring back to FIG. 2B, in an embodiment, the fisheye camera 221 may receive 360° HFOV, and at least 95° vertical field of view (VFOV) above, and 95° VFOV below a horizontal axis, resulting in a 190° VFOV, or approximately 200° diagonal field of view (DFOV). In practice, the capture device may be placed on a table of floor, so a vertical view below the surface may not be needed. Thus, in discussion herein, the VFOV is identified as approximately 95° to indicate a view above the horizontal base plane of the device. In an embodiment, the fisheye camera 221 may include one fisheye sensor of 12 megapixels (MP) (e.g., providing a 4K resolution). The camera lens may be mounted with respect to its image sensor, so that the optical center aligns with the center of the image sensor, and the optical axis is perpendicular to the image sensor. The relative position of the camera module to the microphone array may be fixed and known. In particular, the optical center may also align with the center of the microphone array, with the optical axis perpendicular to the microphone array.

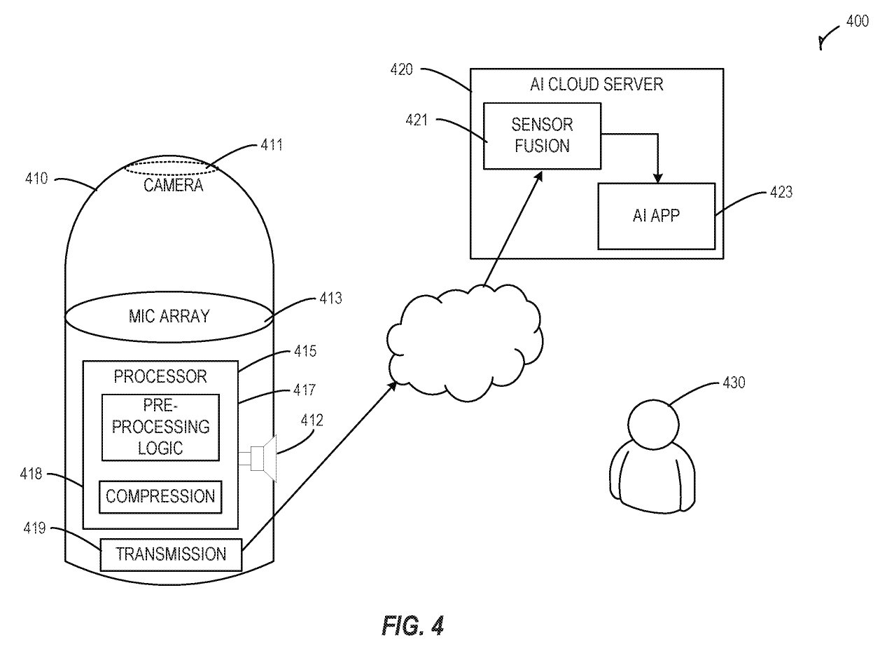

FIG. 4 illustrates an AI system 400 with an ambient capture device 410, as described above, and an AI cloud server 420. In an example, user 430 interacts with an AI application 423. It will be understood that the AI application may reside on the cloud server 420 or on a local device (not shown). Audiovisual data may be captured in 360° by the AI capture device 410. As discussed above, the capture device 410 may include a fisheye camera 411 providing a 360° HFOV and approximately a 95° VFOV. The capture device 410 may include a microphone array 413 to capture audio in 360°. Video compression of the images and video stream received by the camera 411 may be performed by a processor 415 on the device. Video modes and compression protocols and criteria may be controlled by user selectable software controls. In addition to compression, the audiovisual data may be protected by encryption, to prevent unauthorized persons from obtaining the data. In an embodiment, compression 418 may be performed by circuitry on the device and controlled by software switches. Pre-processing 417 (e.g., cropping of images based on image content, or noise reduction) may be performed by logic executed by the processor, before compression 418. In an embodiment, pre-processing may include acoustic echo cancellation (AEC) to reduce feedback, noise, and echo caused by a speaker 412 coupled to the device. In an embodiment, a local process for keyword spotting (KWS) may be included in order to listen for device commands for the ambient capture device, such as to wake or turn off the device. The local KWS may favor recall vs. precision, and it may be based on a reduced microphone array (e.g., two microphones rather than the full array). When AEC is performed on the device 410, the acoustic channel including the speaker audio may not need to be sent to the models to perform sensor fusion 421. The compressed audiovisual data may be sent to a cloud server 420 by a transmission unit 419. Transmission unit 419 may include one or more of: a network interface card for wired communication, such as an Ethernet connection; a wireless transceiver using a wireless protocol such as for WiFi®, Bluetooth®, NFC; or other communication means. In an embodiment, audio feedback may be sent to the device via one of the wireless channels. The AI cloud server 420 may perform sensor fusion 421 for the AI application 423. Therefore, compression may be performed to reduce bandwidth of the transmission to the cloud via a transmission unit 419.

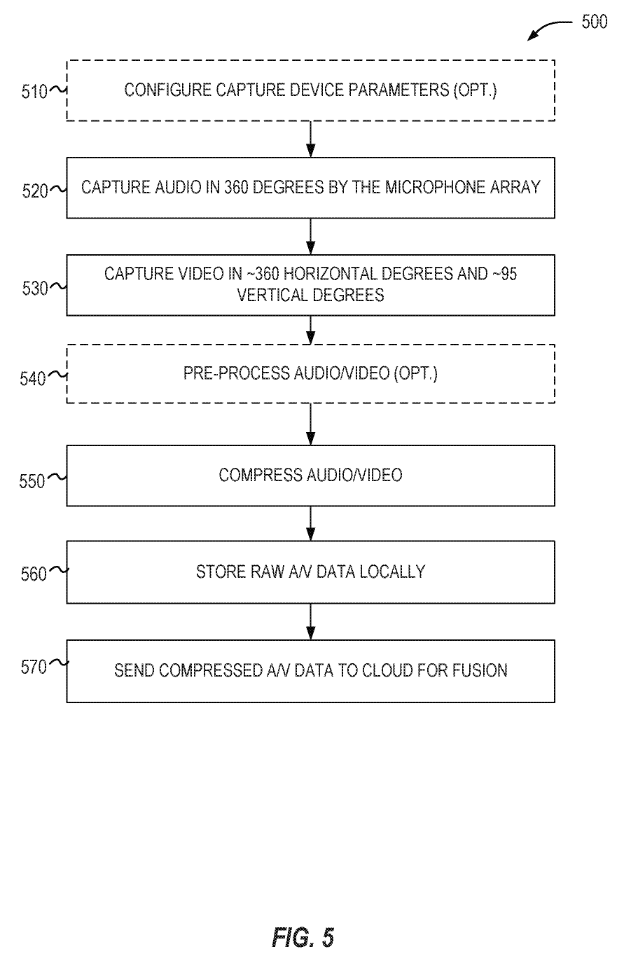

FIG. 5 is a flow diagram illustrating a method 500 for capturing audiovisual data for an AI application, according to an embodiment. In an embodiment, an AI capture device, such as that discussed above, may be used to capture audio and video (or still images). The video component of the capture device may capture images in an approximately 360° HFOV and 95° VFOV. The audio component of the capture device may capture audio in 360° around the device. More than one operational mode may be available for the ambient capture device, and different operational modes may be preferred depending on the desired AI application. An operational mode may comprise a set of configuration parameters for the components of the ambient capture device. For instance, it may not be necessary to adjust for visible fisheye distortion when the user is not going to view the video images. Thus, a lower video resolution operational mode may be selected, or optional fisheye distortion correction configured as turned off. In an application where only rough gesture recognition is required, a lower resolution configuration for collection of video or still images may be acceptable. In an application that requires authentication by facial or voice recognition, a configuration using higher quality audio and video may be selected for an operational mode, etc. In an embodiment, the ambient capture device allows for user selectable configuration parameters to modify the operational mode of the device. Selecting a lower resolution, for instance, may lower bandwidth requirements for transmission of the data, or reduce complexity of the fusion and analysis functions. Some camera parameters may be modifiable for different camera modes. For instance, modifiable camera parameters may include: exposure time, resolution, gain, frame rate, continuous video or, single frame mode. Various microphone configuration parameters may be selected, for instance parameters for adjusting noise or echo correction.

In an example, the user may provide the configuration parameter selections via physical switches on the device, or via a user interface that interacts with a control processor on the device. In an embodiment, the capture device may recognize pre-configured QR codes. When reset, booted, powered on, or otherwise triggered by the user, configuration parameter selection operational mode may be entered, in block 510. In an example, the user may bring the desired QR code within view of the fisheye camera. The fisheye camera may capture an image of the QR code. The device may identify the configuration settings associated with the QR code and adjust the parameters, accordingly.

Once the optional parameter selection e.g., operational mode) is complete, the device may then capture audio and video as defined by the parameters, in blocks 520 and 530, respectively. The audio and video may be timestamped by a common clock for later synchronization and fusion. The device may be an ambient device collecting information in all directions around the device, and be always on, to continue collecting sensor data until powered down. In an embodiment, the microphone array, as discussed above, may capture audio in the environment, in block 520. The raw audio data from each microphone in the array is identified by its location, temporal aspects, etc., so it can be analyzed by a cloud fusion engine. In an embodiment, noise or echo may be eliminated or mitigated before being sent to the AI cloud server. In some examples, the video may be captured 530 by the fisheye camera in 360° HFOV and 95° VFOV using the selected parameters. It will be understood that greater or smaller fields of view may be acceptable, depending on the AI application.

The raw audiovisual data may be optionally pre-processed in block 540. For instance, in an embodiment, noise may be mitigated or eliminated by pre-processing before being stored or transmitted. Noise reduction may be performed by circuitry on the device or by software, hardware or firmware logic coupled to the device processor. Video may be pre-processed for cropping or correction of localized distortion before being stored or transmitted. It will be understood that visible distortion due to the limitations of fisheye camera may not need to be corrected when the user is not going to view the images. Localized distortion may be corrected during pre-processing by circuitry or other logic, or be performed by the AI cloud server. After optional pre-processing is complete, the audiovisual data may be compressed in block 550 for more efficient transmission bandwidth. Compression parameters may be user selectable (e.g., operational mode selection) as in block 510. Audio and/or video data may be encrypted before or after compression to send the data securely.

The audiovisual data may be stored locally for a period of time in either raw format or compressed format, in block 560. The length of time the sensor data is stored may depend on the size of the storage component, and whether the data is compressed or not. Storage persistence duration may be one of the user selectable parameters, as discussed above. In an embodiment, ambient audiovisual data may be stored for several days. If the user is operating multiple AI applications that process and analyze data differently, storage of the raw data may serve to allow an application to access the data for processing after another application has already received and processed the data in a different manner. The compressed audiovisual data (with optional pre-processing) may be transmitted or sent to an AI cloud server for processing, in block 570. The compressed data may be transmitted by wired or wireless connection as packets, streamed data, message passing or stored in a datastore accessible by both the device and the AI cloud server, or by other transmission mechanism. The ambient capture device may be collecting data 24/7, whereas the AI application may not always be running. Thus, audiovisual data may be sent to the AI cloud server upon request, or streaming turned on and off so that unnecessary data will not be sent. In an embodiment, audiovisual data may be continuously sent and unused data (e.g., when the AI application is not running) may be overwritten or discarded as necessary.

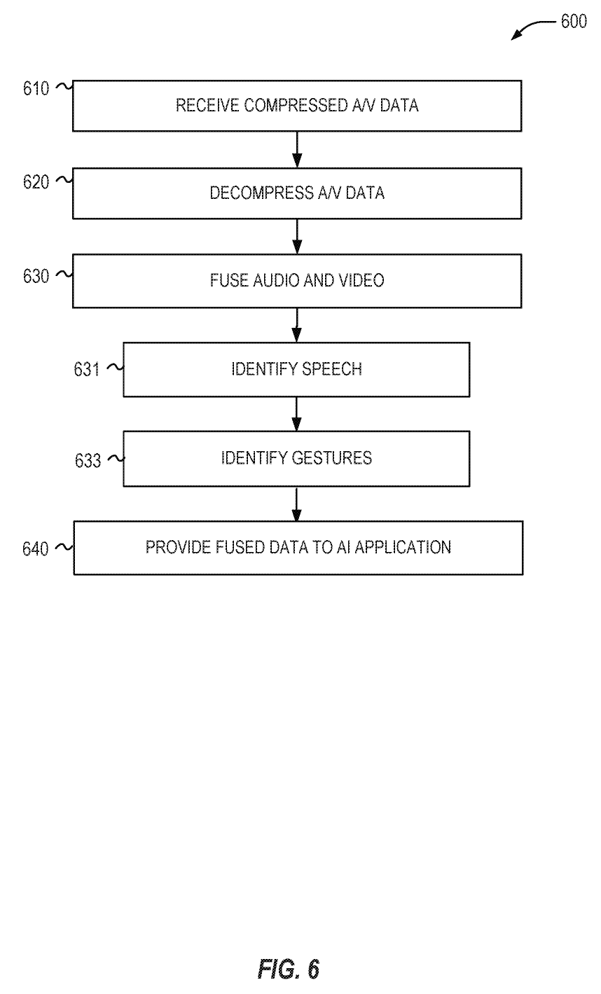

FIG. 6 is a flow diagram illustrating a method 600 for analyzing, processing and fusing the audiovisual data collected by the ambient capture device, according to an embodiment. The compressed audiovisual data is received in block 610, either responsive to a request or automatically. In an embodiment, the audiovisual data may be analyzed by a cloud server. In another embodiment, the analysis engine may be coupled to the capture device as an integrated system. Discussions herein describe the AI cloud server for illustration purposes and not as a limitation. The AI cloud server decompresses, decodes or decrypts the data, as necessary in block 620. The audiovisual data may be fused and analyzed in block 630. In an embodiment, an LSTM model may be used to identify or infer features in the audiovisual data such as, but not limited to: audio direction; speaker location in an image; speaker movement; voice signature; facial signature; gesture; and/or object. In an example, an AI application may require speech recognition or facial recognition. The LSTM model(s) may be trained with data specific to the AI application using the sensor data. In an embodiment, more than one model or analysis engine may be used, as discussed above. In an embodiment, speech may be identified, for instance, in block 631. Gesture recognition using the video data may be performed in block 633. The LSTM model may use the identified speech and the recognized gesture to provide a probable fusion of the data, and send the probable outcomes to the AI application, in block 640. In an example, a gesture combined with a voice command may provide specific control commands to the AI application. In an example, analysis of video data may indicate an eye gaze or track eye movements to infer Where a user is looking. Eye gaze analysis may result in control commands for the AI application, and may differ based on fusion with audio data. In an embodiment, the LSTM model may be trained for a specific AI application and provide the control or commands for that application, based on the fused data. In another embodiment, the LSTM model may be more generic, and provide probable correlated data, such as audio streams for each speaker with a speaker ID and location in the environment, and a video stream, to the AI application for further processing and interpretation of the inputs. In this example, the AI application may use the audio and video stream input to derive the appropriate commands or perform actions. In the conference management example as discussed above, the AI application may take meeting notes and attribute speech to the appropriate speaker, based on correlating the audio streams with voice signatures or identified locations of the users.

An embodiment utilizes a fisheye camera with a 12 MP sensor. Another embodiment may include an infrared (IR) or other depth sensor to provide three dimensional (3D) or depth information. Depth information may not be available in 360° if there are not enough depth sensors to cover the entire HFOV. Variations of the capture device may be provided to accommodate various price points acceptable to a wide range of users, or for different applications. For instance, inclusion of the depth sensors or higher resolution sensors may increase the cost or complexity of the device beyond what is necessary for the selected AI application.

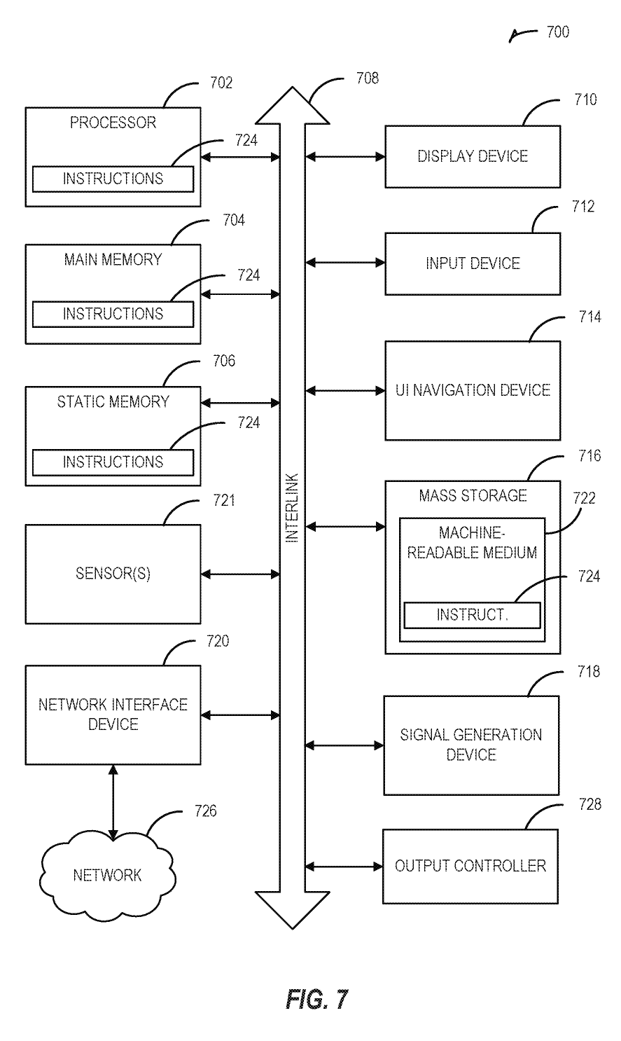

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. In an embodiment, machine 700 may operate as the AI cloud server, as discussed above, or host an AI application for the user, or both. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer readable medium physically modified (e.g., magnetically, electrically, moveable placement of invariant massed particles) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., IR, NFC) connection to communicate or control one or more peripheral devices (e.g., a printer, card reader).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM). Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP)). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

In an embodiment, the ambient capture device may include many of the components of machine 700. For instance, the ambient capture device may include a processor 702, main memory 704 for executing instructions 724 such as for enabling the user selectable configurations. The ambient capture device may include static memory 706 or mass storage 716 for storing the historical raw audiovisual data. Sensors 721 may include the fisheye camera and microphone array. An input device 710 may be available for manual configuration by the user. And a network interface device 720 may send the compressed data to a fusion model for processing. The network interface device 720 may include a transmitter, receiver or combination transceiver component. It will be understood that other architectures may be used for the ambient capture device and AI cloud server, as appropriate.

### ADDITIONAL NOTES AND EXAMPLES

Examples may include subject matter such as a method, means for performing acts of the method, at least one machine-readable medium including instructions that, when performed by a machine cause the machine to performs acts of the method, or of an apparatus or system for an ambient artificial intelligence device, and analysis of audiovisual data collected by sensors of the ambient artificial intelligence device, according to embodiments and examples described herein.

Example 1 is an ambient capture device for collecting and processing sensor information for an artificial intelligence application, comprising: a fisheye camera configured to collect visual data in the vicinity of the ambient capture device, wherein the visual data comprises images, and wherein the fisheye camera collects the visual data in an approximately 360 degree horizontal field of view and at least a 95 degree vertical field of view relative to the ambient capture device; a microphone array including a plurality of microphones configured to capture audio data in the vicinity of the ambient capture device, wherein the audio data includes location information for a source of the audio data; a storage device configured to store the visual data received by the fisheye camera and the audio data received by the microphone array; and a transmission unit configured to send the audio data and the visual data to a data fusion engine, wherein the data fusion engine is configured to process the audio data and the visual data, wherein the processing comprises at least one of audio direction identification, vision detection, vision tracking, speaker location identification, speaker movement identification, voice signature identification, facial signature identification, gesture recognition, eye gaze identification, or object identification, for use in the artificial intelligence application.

In Example 2, the subject matter of Example 1 optionally includes a processor coupled to the ambient capture device; and configuration logic to be executed by the processor, the configuration logic responsive to a user input to configure camera parameters of the fisheye camera, the camera parameters including at least one of exposure time, resolution, gain, frame rate, continuous video or single frame mode.

In Example 3, the subject matter of Example 2 optionally includes wherein the configuration logic is further configured to identify a QR code captured by the fisheye camera and adjust the camera parameters according to a pre-defined set of parameters associated with the QR code.

In Example 4, the subject matter of any one or more of Examples 1-3 optionally include wherein the plurality of microphones are arranged in a plane of the ambient capture device between the fisheye camera and a base of the ambient capture device, wherein the plane is approximately 15 cm from the base and approximately 15 cm from the fisheye camera, and wherein the microphone array is coupled to the ambient capture device in an arrangement that reduces interference with sound blocking components.

In Example 5, the subject matter of Example 4 optionally includes wherein the plurality of microphones include six microphones coupled to the ambient capture device at approximately a same distance from a center microphone of the microphone array, the six microphones arranged generally in a hexagonal shape around the center microphone.

In Example 6, the subject matter of any one or more of Examples 1-5 optionally include an audio speaker coupled to the capture device, wherein the audio speaker is configured to provide audio feedback to a user, wherein the audio speaker is located on the capture device in a manner that reduces acoustic feedback with the microphone array.

In Example 7, the subject matter of any one or more of Examples 1-6 optionally include a processor coupled to the ambient capture device; and compression logic to be executed by the processor, the compression logic configured to compress the audio data and the visual data, and wherein the transmission unit is further configured to send the compressed audio data and visual data to the data fusion engine.

In Example 8, the subject matter of Example 7 optionally includes pre-processing logic to be executed by the processor, the pre-processing logic configured to process the audio data or the visual data before compression, wherein processing of the audio data includes noise reduction and processing of the visual data includes image cropping.

In Example 9, the subject matter of any one or more of Examples 1-8 optionally include a depth camera configured to provide three-dimensional information for at least a portion of the images.

In Example 10, the subject matter of any one or more of Examples 1-9 optionally include wherein the data fusion engine comprises: a processor coupled to memory storing instructions that when executed by the processor cause the data fusion engine to: decompress the audio data and the visual data; and provide a trained machine learning model with the decompressed audio data and visual data to generate at least one input to the artificial intelligence application.

In Example 11, the subject matter of Example 10 optionally includes wherein the trained machine learning model comprises a long short term memory model of a recurrent neural network.

In Example 12, the subject matter of any one or more of Examples 1-11 optionally include wherein responsive to a request to resend information, the ambient capture device is configured to retrieve a portion of the stored audio data or stored visual data, compress the retrieved portion of the audio data or visual data, and wherein the transmission unit is further configured to send the compressed audio data or visual data to the data fusion engine.

Example 13 is a method for analysis of ambient audiovisual data for an artificial intelligence system, comprising: receiving compressed 360 degree audiovisual information from an ambient capture device, the ambient capture device comprising a fisheye camera and a microphone array having a plurality of microphones; decompressing the compressed 360 degree audiovisual information; providing the decompressed 360 degree audiovisual information to a trained machine learning fusion model; receiving, from the fusion model, an identity of at least one active speaker and an audio stream for the at least one active speaker, wherein the at least one active speaker and the audio stream for the at least one active speaker are identified based on the decompressed 360 degree audiovisual information; identifying at least one feature of the 360 degree audiovisual information, the at least one feature including at least one of an audio direction, a speaker location, a speaker movement, a voice signature, a facial signature, an eye gaze, a gesture, or an object; performing facial recognition to identify the at least one active speaker, using the identified at least one feature and the audiovisual information; performing speech recognition on the audio stream for the at least one active speaker; identifying which of the at least one active speaker is associated with the recognized speech, based on the identified at least one feature or facial recognition; generating at least one probable control command for the artificial intelligence system based on the identified at least one feature, facial recognition, or speech recognition; and providing the at least one probable control command to the artificial intelligence system.

In Example 14, the subject matter of Example 13 optionally includes wherein the fusion model comprises a long short term memory model in a recurrent neural network.

In Example 15, the subject matter of any one or more of Examples 13-14 optionally include adjusting visible fisheye image distortion for a localized portion of a 360 degree image to result in an adjusted image; and presenting the adjusted image for display to a user.

In Example 16, the subject matter of any one or more of Examples 13-15 optionally include wherein camera parameters of the ambient capture device are user selectable, and wherein the camera parameters include at least one of exposure time, gain, frame rate, continuous video or single frame mode, wherein at least one of the camera parameters that is user selectable is adjustable based on recognition of a QR code input provided by a user.

Example 17 is a machine readable storage medium having instructions stored thereon, the instructions when executed on a machine cause the machine to: receive audiovisual information from an ambient capture device comprising a fisheye camera and a microphone array having a plurality of microphones, wherein the audiovisual information includes images with approximately a 360 degree horizontal field of view and at least a 95 degree vertical field of view, and wherein the audiovisual information includes audio information having audio source location information derived from at least one of the plurality of microphones; provide the audiovisual information to a trained machine learning fusion model, the fusion model trained for control of or interaction with an artificial intelligence application; receive from the fusion model an identification of at least one active speaker and an audio stream for the at least one active speaker; identify at least one feature in the audiovisual information using the audio stream for the at least one active speaker, wherein the at least one feature includes at least one of an audio direction, a speaker location, a speaker movement, a voice signature, a facial signature, an eye gaze, a gesture, or an object; performing speech recognition on the audio stream for the at least one active speaker; identify which of the at least one active speaker is associated with the speech, based on the identified at least one feature; generate at least one probable command for or interaction with the artificial intelligence application based on the identified at least one feature and the speech recognition; and provide the at least one probable command or interaction to the artificial intelligence application.

In Example 18, the subject matter of Example 17 optionally includes instructions to: perform facial recognition to identify the at least one active speaker, using the identified at least one feature and the audiovisual information, wherein the instructions to identify which of the at least one active speaker is associated with the speech are further based on the facial recognition,

In Example 19, the subject matter of any one or more of Examples 17-18 optionally include instructions to: adjust visible fisheye image distortion for a localized portion of a 360 degree image to result in an adjusted image; and present the adjusted image for display to a user.

In Example 20, the subject matter of any one or more of Examples 17-19 optionally include wherein camera parameters of the ambient capture device are user selectable, and wherein the camera parameters include at least one of exposure time, gain, frame rate, continuous video or single frame mode, wherein the user selectable parameters are adjustable based on recognition of a QR code input provided by a user.

Example 21 is a system for analysis of ambient audiovisual data for an artificial intelligence system, comprising: means for receiving compressed 360 degree audiovisual information from an ambient capture device comprising a fisheye camera and a microphone array having a plurality of microphones; means for decompressing the compressed 360 degree audiovisual information; means for providing the decompressed 360 degree audiovisual information to a trained machine learning fusion model; means for receiving from the fusion model an identity of at least one active speaker and an audio stream for the at least one active speaker, wherein the at least one active speaker and the audio stream for the at least one active speaker are identified based on the decompressed 360 degree audiovisual information; means for identifying at least one feature of the 360 degree audiovisual information, the at least one feature including at least one of an audio direction, a speaker location, a speaker movement, a voice signature, a facial signature, an eye gaze, a gesture, or an object; means for performing facial recognition to identify the at least one active speaker, using the identified at least one feature and the audiovisual information; means for performing speech recognition on the audio stream for the at least one active speaker; means for identifying which of the at least one active speaker is associated with the recognized speech, based on the identified at least one feature or facial recognition; means for generating at least one probable control command for the artificial intelligence system based on the identified at least one feature, facial recognition, or speech recognition; and providing the at least one probable control command to the artificial intelligence system.

In Example 22, the subject matter of Example 21 optionally includes wherein the fusion model comprises a long short term memory model in a recurrent neural network.

In Example 23, the subject matter of any one or more of Examples 21-22 optionally include means for adjusting visible fisheye image distortion for a localized portion of a 360 degree image to result in an adjusted image; and presenting the adjusted image for display to a user.

In Example 24, the subject matter of any one or more of Examples 21-23 optionally include wherein camera parameters of the ambient capture device are user selectable, and wherein the camera parameters include at least one of exposure time, gain, frame rate, continuous video or single frame mode, wherein the user selectable parameters are adjustable based on recognition of a QR code input provided by a user.

Example 25 is a system configured to perform operations of any one or more of Examples 1-24.

Example 26 is a method for performing operations of any one or more of Examples 1-24.

Example 27 is at least one machine readable medium including instructions that, when executed by a machine cause the machine to perform the operations of any one or more of Examples 1-24.

Example 28 is a system comprising means for performing the operations of any one or more of Examples 1-24.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. An ambient capture device for collecting and processing sensor information for an artificial intelligence application, comprising:
a fisheye camera configured to collect visual data in the vicinity of the ambient capture device, wherein the visual data comprises images, and wherein the fisheye camera collects the visual data in an approximately 360 degree horizontal field of view and at least a 95 degree vertical field of view relative to the ambient capture device;
a microphone array including a plurality of microphones configured to capture audio data in the vicinity of the ambient capture device, wherein the audio data includes location information for a source of the audio data;
a storage device configured to store the visual data received by the fisheye camera and the audio data received by the microphone array; and
a transmission unit configured to send the audio data and the visual data to a data fusion engine, wherein the data fusion engine is configured to process the audio data and the visual data, wherein the processing comprises at least one of audio direction identification, vision detection, vision tracking, speaker location identification, speaker movement identification, voice signature identification, facial signature identification, gesture recognition, eye gaze identification, or object identification, for use in the artificial intelligence application.

2. The device as recited in claim 1, further comprising:
a processor coupled to the ambient capture device; and
configuration logic to be executed by the processor, the configuration logic responsive to a user input to configure camera parameters of the fisheye camera, the camera parameters including at least one of exposure time, resolution, gain, frame rate, continuous video or single frame mode.

3. The device as recited in claim 2, wherein the configuration logic is further configured to identify a QR code captured by the fisheye camera and adjust the camera parameters according to a pre-defined set of parameters associated with the QR code.

4. The device as recited in claim 1, wherein the plurality of microphones are arranged in a plane of the ambient capture device between the fisheye camera and a base of the ambient capture device, wherein the plane is approximately 15 cm from the base and approximately 15 cm from the fisheye camera, and wherein the microphone array is coupled to the ambient capture device in an arrangement that reduces interference with sound blocking components.

5. The device as recited in claim 4, wherein the plurality of microphones include six microphones coupled to the ambient capture device at approximately a same distance from a center microphone of the microphone array, the six microphones arranged generally in a hexagonal shape around the center microphone.

6. The device as recited in claim 1, further comprising an audio speaker coupled to the capture device, wherein the audio speaker is configured to provide audio feedback to a user, wherein the audio speaker is located on the capture device in a manner that reduces acoustic feedback with the microphone array.

7. The device as recited in claim 1, further comprising:
a processor coupled to the ambient capture device; and
compression logic to be executed by the processor, the compression logic configured to compress the audio data and the visual data, and
wherein the transmission unit is further configured to send the compressed audio data and visual data to the data fusion engine.

8. The device as recited in claim 7, further comprising:
pre-processing logic to be executed by the processor, the pre-processing logic configured to process the audio data or the visual data before compression, wherein processing of the audio data includes noise reduction and processing of the visual data includes image cropping.

9. The device as recited in claim 1, further comprising a depth camera configured to provide three-dimensional information for at least a portion of the images.

10. The device as recited in claim 1, wherein the data fusion engine comprises:
a processor coupled to memory storing instructions that when executed by the processor cause the data fusion engine to:
decompress the audio data and the visual data; and
provide a trained machine learning model with the decompressed audio data and visual data to generate at least one input to the artificial intelligence application.

11. The device as recited in claim 10, wherein the trained machine learning model comprises a long short term memory model of a recurrent neural network.

12. The device as recited in claim 1, wherein responsive to a request to resend information, the ambient capture device is configured to retrieve a portion of the stored audio data or stored visual data., compress the retrieved portion of the audio data or visual data, and
wherein the transmission unit is further configured to send the compressed audio data or visual data to the data fusion engine.

13. A method for analysis of ambient audiovisual data for an artificial intelligence system, comprising:
receiving compressed 360 degree audiovisual information from an ambient capture device, the ambient capture device comprising a fisheye camera and a microphone array having a plurality of microphones;
decompressing the compressed 360 degree audiovisual information;
providing the decompressed 360 degree audiovisual information to a trained machine learning fusion model;
receiving, from the fusion model, an identity of at least one active speaker and an audio stream for the at least one active speaker, wherein the at least one active speaker and the audio stream for the at least one active speaker are identified based on the decompressed 360 degree audiovisual information;
identifying at least one feature of the 360 degree audiovisual information, the at least one feature including at least one of an audio direction, a speaker location, a speaker movement, a voice signature, a facial signature, an eye gaze, a gesture, or an object;
performing facial recognition to identify the at least one active speaker, using the identified at least one feature and the audiovisual information;
performing speech recognition on the audio stream for the at least one active speaker;
identifying which of the at least one active speaker is associated with the recognized speech, based on the identified at least one feature or facial recognition;
generating at least one probable control command for the artificial intelligence system based on the identified at least one feature, facial recognition, or speech recognition; and
providing the at least one probable control command to the artificial intelligence system.

14. The method as recited in claim 13, wherein the fusion model comprises a long short term memory model in a recurrent neural network.

15. The method as recited in claim 13, further comprising:
adjusting visible fisheye image distortion for a localized portion of a 360 degree image to result in an adjusted image; and
presenting the adjusted image for display to a user.

16. The method as recited in claim 13, wherein camera parameters of the ambient capture device are user selectable, and wherein the camera parameters include at least one of exposure time, gain, frame rate, continuous video or single frame mode, wherein at least one of the camera parameters that is user selectable is adjustable based on recognition of a QR code input provided by a user.

17. A machine readable storage medium having instructions stored thereon, the instructions when executed on a machine cause the machine to:
receive audiovisual information from an ambient capture device comprising a fisheye camera and a microphone array having a plurality of microphones, wherein the audiovisual information includes images with approximately a 360 degree horizontal field of view and at least a 95 degree vertical field of view, and wherein the audiovisual information includes audio information having audio source location information derived from at least one of the plurality of microphones;
provide the audiovisual information to a trained machine learning fusion model, the fusion model trained for control of or interaction with an artificial intelligence application;
receive from the fusion model an identification of at least one active speaker and an audio stream for the at least one active speaker;
identify at least one feature in the audiovisual information using the audio stream for the at least one active speaker, wherein the at least one feature includes at least one of an audio direction, a speaker location, a speaker movement, a voice signature, a facial signature, an eye gaze, a gesture, or an object;
performing speech recognition on the audio stream for the at least one active speaker;
identify which of the at least one active speaker is associated with the speech, based on the identified at least one feature;
generate at least one probable command for or interaction with the artificial intelligence application based on the identified at least one feature and the speech recognition; and
provide the at least one probable command or interaction to the artificial intelligence application.

18. The medium as recited in claim 17, further comprising instructions to:
perform facial recognition to identify the at least one active speaker, using the identified at least one feature and the audiovisual information, wherein the instructions to identify which of the at least one active speaker is associated with the speech are further based on the facial recognition.

19. The medium as recited in claim 17, further comprising instructions to:
adjust visible fisheye image distortion for a localized portion of a 360 degree image to result in an adjusted image; and
present the adjusted image for display to a user.

20. The medium as recited in claim 17, wherein camera parameters of the ambient capture device are user selectable, and wherein the camera parameters include at least one of exposure time, gain, frame rate, continuous video or single frame mode, wherein the user selectable parameters are adjustable based on recognition of a QR code input provided by a user.
